(19) United States
(12) Patent Application Publication
(10) Pub. No.: US 2016/0236300 A1
(43) Pub. Date: Aug. 18, 2016

(54) DEVICE FOR THE LASER MARKING OF PRODUCTS

(71) Applicant: MACSA ID, S.A., Manresa (Barcelona) (ES)

(72) Inventors: Sven Alexander Vogler, Manresa (Barcelona) (ES); Joan Camps Claramunt, Manresa (Barcelona) (ES); Francisco Bravo Montero, Manresa (Barcelona) (ES)

(21) Appl. No.: 14/991,093

(22) Filed: Jan. 8, 2016

(30) Foreign Application Priority Data
Jan. 9, 2015 (ES) 201530021

(51) Int. Cl. B23K 26/70; B23K 26/362

(52) U.S. Cl. CPC B23K 26/703; B23K 26/362

(57) ABSTRACT

Device for the laser marking of products, of the type that comprises an outer casing defining at least one internal volume, the said internal volume comprising: at least one laser beam generating source, at least one optical system for the output from the laser, and electronic and control means of the device, the said casing additionally comprising at least one air outlet of the device, and at least one fan for generating a flow of cooling air from the generating source and the electronic and control means of the device through interior of the casing between the said air inlet and the said air outlet, wherein the said air inlet is more distant from the said laser output than the air output.

The present invention relates to the field of devices for the laser marking and industrial coding of products. In particular, the present invention relates to the cooling system that incorporates a device of this type, also known as a laser marking device.

The cooling systems of the laser marking devices known in the prior art take in air from the front area of the appliance, this being the area that usually houses the lens through which the laser beam is projected towards the exterior of the device, and cause this air to pass through the interior of the device towards the rear part, i.e. opposite to the front part, where the air is expelled to the outside of the device. A problem with this type of cooling system lies in the fact that the front area of the device is the area that tends to contain the most dust and dirt due to its operation, so that the air that enters the appliance is dirty.

Additionally, to reduce the amount of dirt from the air taken in through the front of the device it is necessary to use filters. However, despite the use of filters, the entry of dust and/or dirt into the interior of the device is inevitable, and this results in a reduction of its durability due to low protection of the device against penetration by dust and/or foreign bodies, according to the IP (Internal Protection) indices defined in the international standard IEC 60529.

In such systems, the air usually passes through the whole of the interior of the device, entering into contact both with the laser generator and with the electronic systems of the laser marking device. In this case, the dirt that enters from the outside therefore affects all the systems that are contained inside the device. Moreover, the laser generator gives off more heat than the other components, so that this ventilation arrangement does not appear to be the most efficient, since it cools in equal measure the whole of a unit that has, in reality, different cooling needs.

Additionally, the lens of a laser marking device tends to accumulate dirt during the operation of the device. Consequently, in many cases, the only way of cleaning the lens is by removing it from the device, and this can result in it being stopped at inopportune moments, such as for example during its operation for marking or engraving products in a production line.

In view of the above, an aim of the present invention is to solve the disadvantages of the known systems for the cooling of laser marking devices.

According to the present invention, this is accomplished by a device for the laser marking of products of the type that comprises an outer casing defining at least one internal volume, the said internal volume comprising:
at least one laser beam generating source,
at least one optical system for the output from the laser,
electronic and control means of the device,
   the said casing additionally comprising at least one air inlet and one air outlet of the device, and at least one fan for generating a flow of air for cooling the generating source and the electronic and control means of the device through the interior of the casing between the said air inlet and the said air outlet, characterised in that the air inlet is more distant from the laser output than the air outlet.

Preferably, the optical system is arranged in a first end of the device, such as the front area of the device, this being the area that usually houses the lens through which the laser beam is projected towards the exterior of the device.

Preferably, also, the air inlet is arranged in a second end of the device, such as the rear part, opposite to the front, this being an area where the air is cleaner. The said second end being opposite to the said first end, allowing a flow of air through the interior of the device towards the air outlet, the said air outlet being arranged in an area closer to the optical system than the air inlet.

Optionally, the fan is arranged adjacent to the air inlet. According to another embodiment of the present invention, the fan is arranged adjacent to the air outlet of the laser device, thus allowing the warm air to be aspirated from the interior of the internal volume of the said device and expelled towards the exterior of the same.

Optionally, the device for the laser marking of products comprises a fan adjacent to the air inlet and a fan adjacent to the air outlet.

In an embodiment of the invention, the electronic and control means are in turn situated in a closed volume that comprises a heat exchanger which communicates thermally with the said air flow that passes through the interior of the internal volume.

Preferably, the said closed volume comprises ventilation means to allow the circulation of air inside the said closed volume.

Optionally, the said internal volume comprises a bypass, adjacent to the air inlet, that connects with a pipe arranged in the extrusion of the casing that runs longitudinally along the casing to an opening where the laser output lens is situated, allowing the circulation of air through the said pipe from the air inlet to the said opening.

In an embodiment of the invention, the optical system comprises at least one laser output lens.

In the device of the present invention, the outer casing defines an internal volume through which the air flows. The said internal volume has, in turn, another completely closed volume containing the electronic and control devices, with no air inlet or outlet. In the said closed volume, the air is recirculated by a number of fans so that the warm air comes into contact with a heat exchanger provided with fins on both sides. The said exchanger has one face in the closed volume of the electronic systems and another face in the said internal volume through which the air passes. The heat absorbed in the volume of the electronic and control devices is transmitted via the exchanger to its other face so that it is dissipated by the air.

The internal volume contains only the laser generator and is the only internal volume of the appliance through which air from the exterior enters and exits. The said volume is open through the rear and front parts of the appliance, as in the known devices of the prior art. However, in the present invention the air flow is in the reverse direction: the air enters the device through the rear part, this being an area where the air is cleaner, and exits the device through the front part, which is where most of the dirt accumulates in the device. It is not necessary for the air inlets and outlets to be sealed, since the laser generator is covered by a protector that seals its interior.

A fan arranged adjacent to the air inlet generates the flow of cooling air. Optionally, a fan (not illustrated) can be added, arranged adjacent to the air outlet, which can replace the fan arranged at the air inlet or function as a complement to the fan at the air inlet.

As a consequence of the entry of clean air through the rear area of the device and the protection of the laser generator, the insulation and therefore the durability of the said generator are greater than in laser generators of the known devices. The same is true for the electronic and control devices due to the fact that they are situated inside a completely closed volume.

Additionally, the device comprises a bypass situated adjacent to the rear air inlet which diverts air from the internal volume of the device to a pipe formed in the extrusion of the casing of the device. This air passes through the entire device via the said pipe until it reaches the opening where the laser lens is situated. In this way, the air coming from the rear part of the device also serves to clean the lens in a simple manner, preventing the accumulation of dirt on the lens. It is therefore not necessary to stop the operation of the apparatus in order to perform this task. The diversion takes place in the rear part of the device in order to take advantage of the large difference in pressure and ensure that the air arrives at the lens with sufficient force.

The air-cooling of the device according to the present invention is more effective than in the devices known from the prior art, because the dissipating effect of the air is focused on the laser generator, which is the component of the device that gives off the most heat. The heat exchanger ensures that the cooling air also cools the electronic components area, which generates heat to a lesser degree.

To allow a clearer understanding, by way of explanatory and non-limitative example, some drawings are attached of an embodiment of the laser marking device and its cooling system forming the subject of the present invention.

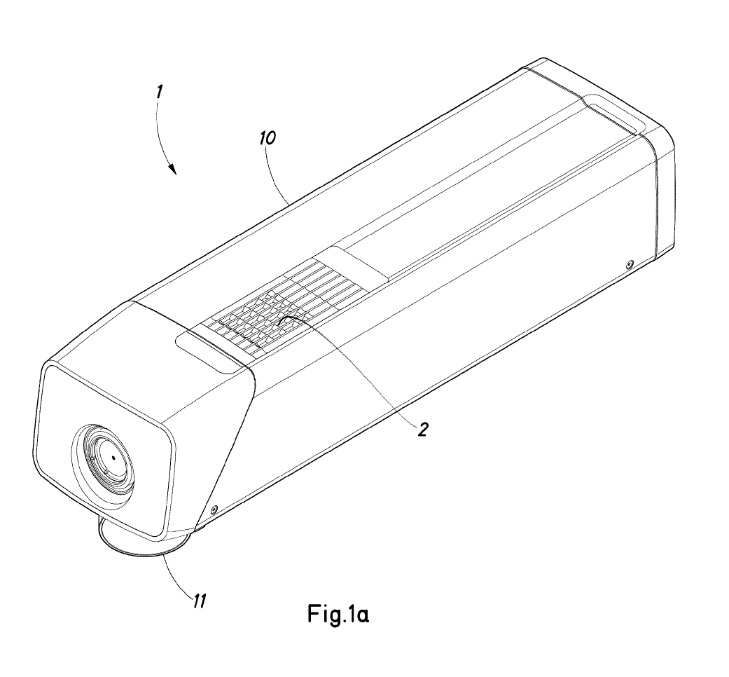

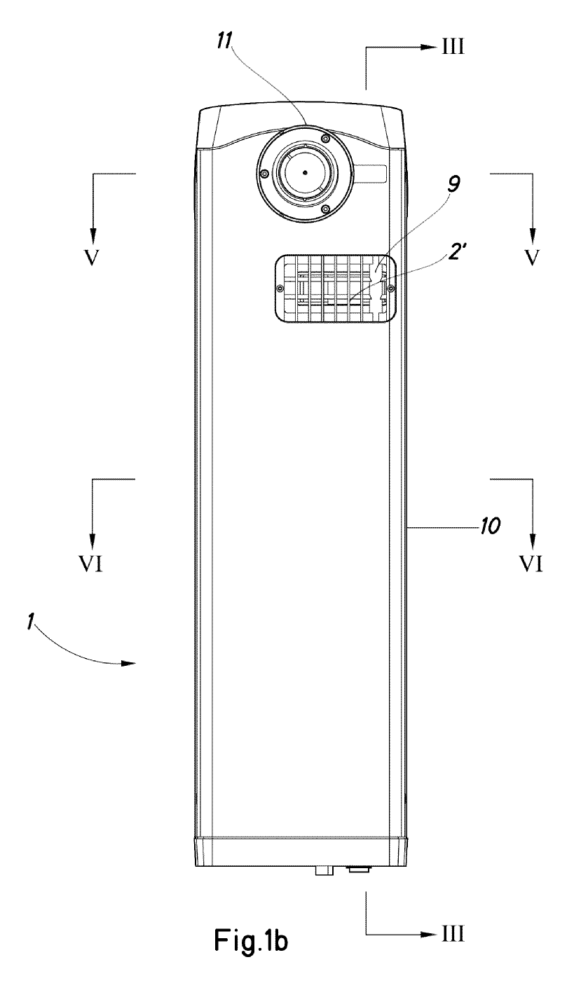

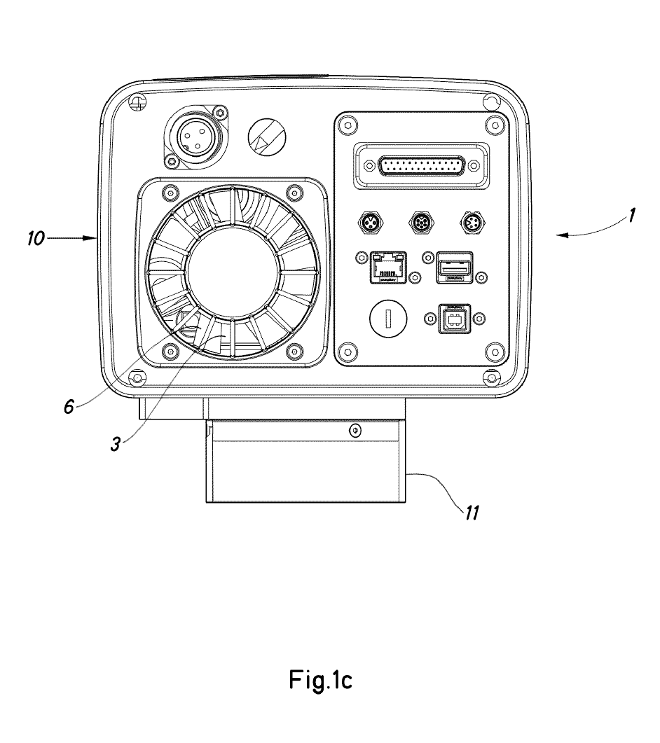

FIGS. 1a to 1c provide different views of an embodiment of a laser marking device according to the present invention: FIG. 1a shows a perspective view of the device; FIG. 1b shows a plan view of the lower part of the device; and FIG. 1c shows a rear view of the device.

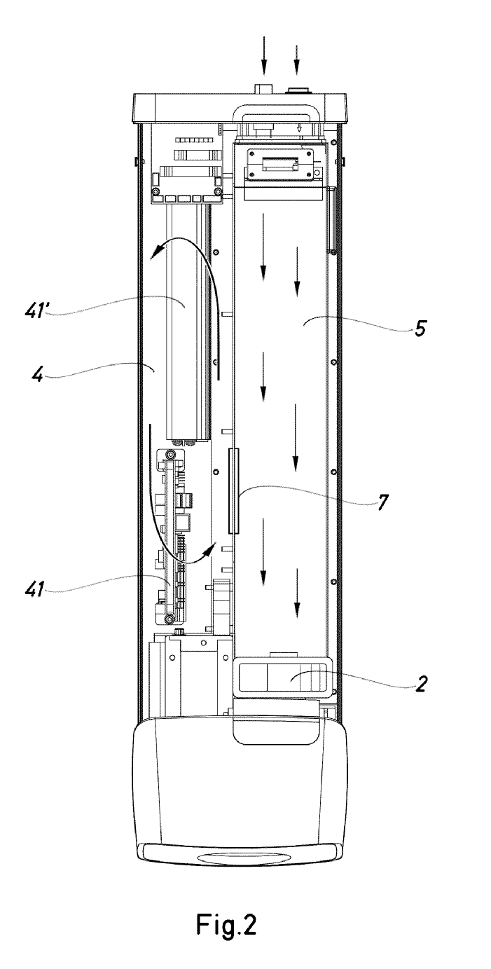

FIG. 2 shows a top plan view of an embodiment of a laser marking device according to the present invention, with its outer casing removed.

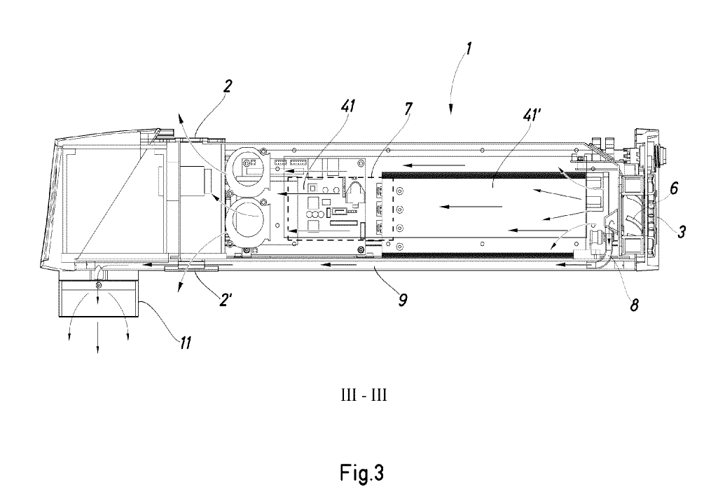

FIG. 3 shows a longitudinal cross-section of an embodiment of a laser marking device with no outer casing at the level of the pipe, through the plane III-III of FIG. 1b.

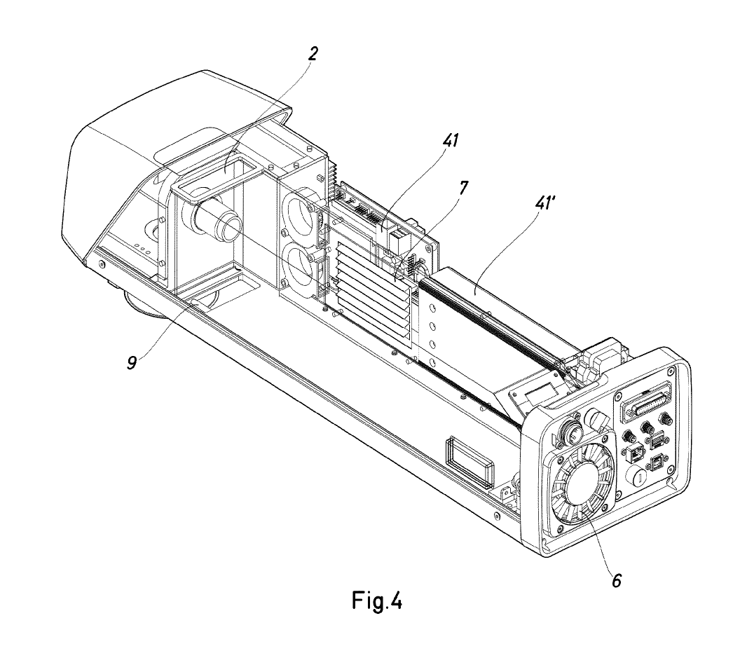

FIG. 4 shows a perspective view of an embodiment of a laser marking device with no outer casing, according to the present invention.

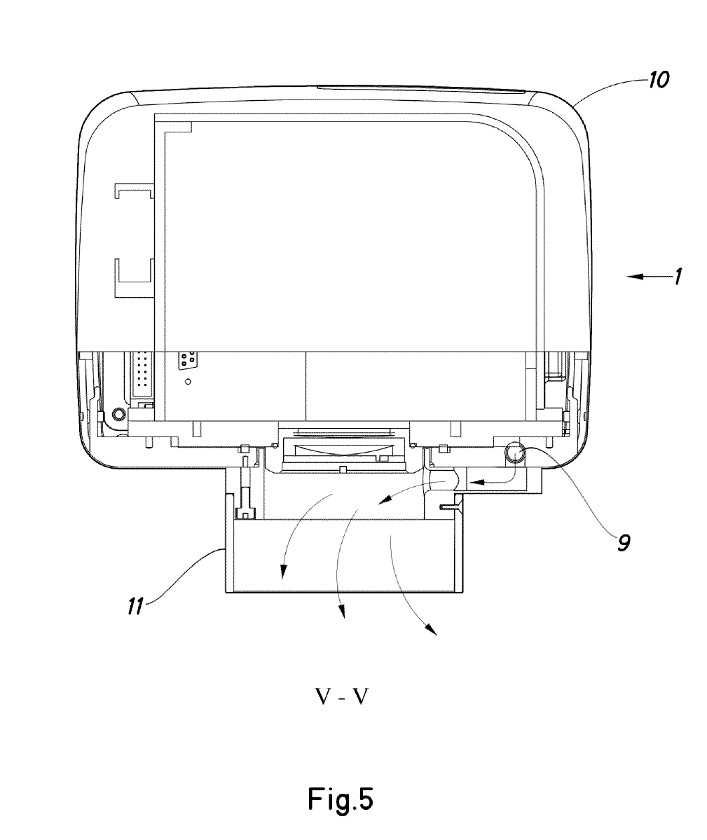

FIG. 5 shows a transverse cross-section of an embodiment of a laser marking device with no outer casing at the level of the lens, through the plane V-V of FIG. 1b.

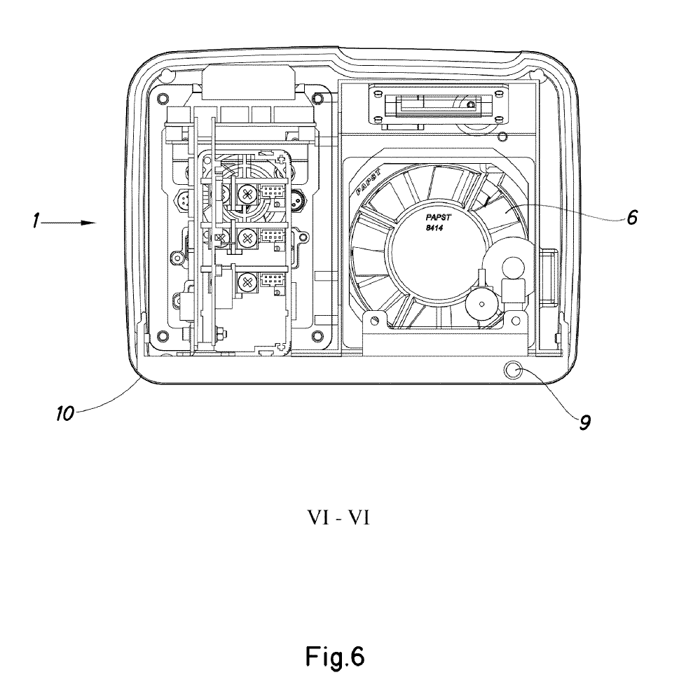

FIG. 6 shows another transverse cross-section of an embodiment of a laser marking device mid-way along its length, through the plane VI-VI of FIG. 1b.

FIGS. 1a, 1b and 1c show the laser marking device -1-, which has an outer casing -10-. The interior of the said casing -10- accumulates heat due to the operation of the different elements or components contained in its interior. In order to cool the interior of the casing -10-, the casing has an air inlet -3-, arranged in the rear part of the device -1- as shown in FIG. 1c, and two air outlets -2, 2′-, arranged in the upper and lower parts of the front part of the device -1- and shown in FIGS. 1a and 1b.

FIG. 2 shows the interior of the casing -10-, which when the casing is in place has a closed volume -4- and a volume -5- communicating with the exterior via the said air inlet -3- and the said air outlets -2, 2′-. A fan -6- situated in the rear part of the device introduces air from the exterior of the device -1- to the interior of the same via the air inlet -3-, allowing the air to enter into the volume -5- and pass through the same to the air outlets -2, 2′-. The laser generator (not illustrated) is situated in the interior of the volume -5-, so that the air circulation dissipates the heat given off by the said generator.

In the interior of the closed volume -4- are situated the electronic components -41, 41′- of the device -1-, whose operation also gives off heat, albeit to a lesser degree than the laser generator. A number of fans (not illustrated) allow the air to be recirculated through the interior of the closed volume. Additionally, the device -1- comprises a heat exchanger -7- with fins on two faces, one of the faces of the exchanger -7- being situated inside the closed volume -4- and the other face of the exchanger -7- being situated inside the internal volume -5-. In this way, the exchanger -7-transfers the heat generated in the interior of the closed volume -4- to the internal volume -5-, and the said heat is dissipated thanks to the air circulation that takes place in the interior of the said internal volume -5-.

In the longitudinal cross-section of the device -1- shown in FIG. 3 can be seen a bypass -8- situated adjacent to the air inlet -3- and in the interior of the internal volume -5-, which connects with a pipe -9- that runs longitudinally along the interior of the casing to an opening where the laser output lens -11- is situated. Through the said pipe -9- is diverted air from the exterior of the device -1-, and the said air passes along the said pipe -9- towards the opening where the laser lens -11- is situated, subjecting the lens -11- to a current of air that prevents the accumulation of dirt.

The arrows shown in FIGS. 3 and 4 represent the flow of cooling air.

FIG. 4 shows in greater detail the passage of the pipe 9 through the lower outlet -2′-. As shown in FIG. 5, the lens -11- is connected with the said pipe -9- in order to allow the air that arrives through the said pipe 9 to be blown on to the lens -11-, thus allowing it to be cleaned and ventilated. The said pipe -9- forms part of the casing as mentioned previously and as shown in FIG. 6.

Although the invention has been described with respect to a preferred embodiment, the said embodiment must not be regarded as limitative of the invention, which will be defined by the broadest interpretation of the following claims.

1. Device for the laser marking of products, of the type that comprises an outer casing defining at least one internal volume, the said internal volume comprising:
at least one laser beam generating source,
at least one optical system for the output from the laser,
electronic and control means of the device,
the said casing additionally comprising at least one air inlet and one air outlet of the device, and at least one fan for generating a flow of air for cooling the generating source and the electronic and control means of the device through the interior of the casing between the said air inlet and the said air outlet, characterised in that the air inlet is more distant from the laser output than the air outlet.

2. Device for the laser marking of products, according to claim 1, characterised in that the optical system is arranged in a first end of the device and in that the air inlet is arranged in a second end of the device, opposite to the said first end, allowing a flow of air through the interior of the device towards the air outlet, the said air outlet being arranged in an area closer to the optical system than the air inlet.

3. Device for the laser marking of products, according to claim 2, characterised in that the fan is arranged adjacent to the air inlet.

4. Device for the laser marking of products, according to claim 2, characterised in that the fan is arranged adjacent to the air outlet.

5. Device for the laser marking of products, according to claim 2, characterised in that it comprises a fan adjacent to the air inlet and a fan adjacent to the air outlet.

6. Device for the laser marking of products, according to claim 1, characterised in that the electronic and control means are in turn situated in a closed volume that comprises a heat exchanger which communicates thermally with the said air flow that passes through the interior of the internal volume.

7. Laser marking device according to claim 6, characterised in that the said closed volume comprises ventilation means to allow the circulation of air inside the said closed volume.

8. Laser marking device according to claim 1, characterised in that the said internal volume comprises a bypass, adjacent to the air inlet, that connects with a pipe arranged in the extrusion of the casing that runs longitudinally along the casing to an opening where the laser output lens is situated, allowing the circulation of air through the said pipe from the air inlet to the said opening.

9. Laser marking device according to claim 1, characterised in that the optical system comprises at least one laser output lens.
